(19) United States
(12) Patent Application Publication
(10) Pub. No.: US 2013/0207767 A1
(43) Pub. Date: Aug. 15, 2013

(54) Planar Transformers

(71) Applicant: Kenneth R. Worthington, Cheshire (GB)

(72) Inventor: Kenneth R. Worthington, Cheshire (GB)

(73) Assignee: MICROMASS UK LIMITED, Manchester (GB)

(21) Appl. No.: 13/703,915

(22) PCT Filed: Jun. 27, 2011
(86) PCT No.: PCT/GB2011/051207

§ 371 Date: Mar. 12, 2013

(30) Foreign Application Priority Data
Jul. 1, 2010 (GB) 1011085.6

(51) Int. Cl. H01F 27/36

(52) U.S. Cl. CPC H01F 27/365
USPC 336/84 C

(57) ABSTRACT

A planar transformer comprises a plurality of conductive windings provided by at least one PCB and linked by a common ferrite core passing through the or each PCB. The transformer windings are at least partially magnetically shielded from the ferrite core by a conductive non-continuous shield formed by copper planed areas on one or more of the PCB layers to improve the coupling between the windings.

This invention relates to improvements in planar transformers and, more specifically but not exclusively, to a transformer with an inductance controlled by a gap in the magnetic circuit and improved coupling between windings. Such transformers are particularly useful for ion guides, particularly for use in mass spectrometers, and the improvements derived from the present invention give better control of the ions in the ion guide.

### BACKGROUND OF THE INVENTION

A planar transformer generally consists of two or more windings formed by copper tracks, on one or more PCBs. All the windings are linked by a common ferrite core which passes through slots in the PCB. The transformer may comprise two ‘E’-core components or an ‘E’-core and an ‘I’-core.

During operation when a current is injected in the windings, the magnetic flux produced by the windings will close through the magnetic material. The magnetic flux paths pass through the outer legs of the magnetic core and through the centre leg. Around the gap area of the centre leg of the core material the magnetic flux paths are spread outside of the centre leg due to the low permeability of the material placed in the gap, which is usually air. Some of these flux paths cut into the windings and the component of the magnetic field perpendicular to the planar windings induces eddy currents into the winding. The eddy currents developed in the winding will create a magnetic field which will oppose the component of the magnetic field perpendicular to the winding. The eddy currents developed in the planar winding will lead to additional power dissipation reducing the efficiency of the transformer and will create a temperature rise in the planar winding.

In the ideal situation all the magnetic flux is contained within the ferrite core and the intentional gap within the magnetic circuit. However, the stray magnetic flux which occurs around the ferrite and particularly around the magnetic gap cannot pass through the actual copper tracks making up the winding, but can pass between windings, or between the turns of multi-turn windings. This is shown schematically in FIG. 1 of the drawings.

As a result, the magnetic flux does not link all the windings equally, and the effects are seen either as an additional specific inductance associated with individual windings, or winding voltages that are out of proportion with the turns-ratio. This is commonly known as either leakage inductance, or leakage reactance.

Due to the low profile of planar ferrite cores, the magnetic gap length becomes comparable with the height of the winding aperture. This encourages flux leakage between the core halves, around the magnetic gap.

Coaxial or twisted cables are known to be used to create transformers with good coupling between windings. Also it is known to use magnetic gaps to control inductance and prevent magnetic saturation of transformers.

U.S. Pat. No. 6,967,553 discloses the use of conductive shields around the magnetic gap in planar ferrite cores as a method of reducing eddy current losses in a single winding.

U.S. Pat. No. 3,336,662 discloses the use of conductive shields around a toroidal ferrite core. The invention disclosed relates to a low leakage-inductance transformer and in particular to a high frequency transformer with a magnetic core shielded from the windings by a chemically and electrically deposited electrostatic shield.

U.S. Pat. No. 5,598,327 discloses the use of electrostatic shielding used within a planar transformer. The planar transformer assembly includes an insulative layer, a first spiral winding thereon circumscribing a magnetic flux path, a second spiral winding thereon in non-overlapping relation to the first spiral winding circumscribing the magnetic flux path, and a ferrite core assembly including first and second core sections defining a shallow gap or passage within which the spiral windings are disposed. In one embodiment, a plurality of laminated insulative layers are provided with a primary winding including a plurality of series-connected spiral subwindings and a non-overlapping secondary winding formed on the various insulative layers. The non-overlapping structure and the order of the various windings minimize electric field gradients and thereby minimize electric field coupled noise currents.

A particular application of a planar transformer of the present invention is to energise a stacked ring plate ion guide within a mass spectrometer instrument.

Such an ion guide comprises a number of plate electrodes which must be supplied with differing combinations of AC, DC and pulse potentials. Ideally, for the effective containment and transport of ions through the guide, the AC potentials on all the plates should be equal. However, the AC phases between adjacent plates should be opposite.

For each different plate potential, a separate output is required, and this is most easily supplied using a transformer with multiple closely coupled windings. This is used to apply the AC component output differentially across its windings, and apply the DC and pulse voltages via each winding centre tap.

In order to provide consistent repeatable potentials on the ion guide plates, it is desirable to have the correct proportion of the primary AC induced equally into all the secondary winding outputs.

### SUMMARY OF THE INVENTION

According to one aspect of the present invention, there is provided a planar transformer comprising one or more, e.g. two or more, preferably a plurality of conductive windings provided by at least one printed circuit board (PCB) and linked by a common ferrite core passing through the or each PCB, wherein the transformer windings or winding tracks and/or gaps therebetween are at least partially magnetically shielded from the ferrite core by a conductive non-continuous shield, e.g. thereby to improve the coupling between windings.

The conductive shield may form a single turn winding and/or may be connected to ground as both a magnetic and electrostatic shield.

The conductive shield may be formed by copper planed areas on one or more of the PCB layers. Preferably, the copper shielding planes and windings or winding tracks are located on different layers of the or each PCB.

The shielded area may be extended to cover at least a portion of the PCB area outside the ferrite core.

The windings and/or shielding may be remote from, e.g. spaced from or kept clear of the transformer magnetic gap, for example to minimize eddy current losses. Preferably, the clearance or space between the windings and/or shielding and the transformer magnetic gap is approximately, e.g. substantially, five times the length of the magnetic gap.

The shield may be on the upstream side of the PCB in the direction of the magnetic flux. The shield may comprise a metal foil disposed between the PCB and the ferrite material.

The ferrite core may comprise an E-shape. The conductive shield may be located between the windings and the ferrite core or E-shaped ferrite core, for example on the ferrite core facing side, e.g. the E-shaped ferrite core facing side, of the PCB, for example at or adjacent the major surface of the PCB facing the ferrite core or E-shaped ferrite core. A further conductive shield may be located on the side of the PCB opposite the ferrite core or E-shaped ferrite core facing side of the PCB.

Other aspects of the invention provide a circuit board having a planar transformer as described above. The circuit board is preferably for a mass spectrometer and/or an ion guide of a mass spectrometer.

A further aspect of the invention provides an ion guide comprising a planar transformer or a printed circuit board as described above. A yet further aspect of the invention provides a mass spectrometer comprising a planar transformer or a printed circuit board or an ion guide as described above.

### BRIEF DESCRIPTION OF THE DRAWINGS

Embodiments of the invention will now be described, by way of example, with reference to the accompanying drawings, in which:

FIG. 1 illustrates schematically the existing problem of stray flux paths in planar transformers;

FIG. 2 illustrates schematically a planar transformer of the present invention having two shielded areas created on the winding PCB;

FIG. 2A is a partial cross-sectional view through the PCB of FIG. 2;

FIG. 3A illustrates schematically a planar transformer according to one embodiment of the invention having a single PCB with ‘E’ and ‘I’ cores;

FIG. 3B illustrates schematically a planar transformer according to another embodiment of the invention having two PCBs with ‘E’ and ‘I’ cores;

FIG. 3C illustrates schematically a planar transformer according to yet another embodiment of the invention having two PCBs with two ‘E’ cores; and

FIG. 3D illustrates schematically a planar transformer according to a yet further embodiment of the invention similar to that of FIG. 3C, but in which the two ‘E’ cores are externally gapped.

### DETAILED DESCRIPTION OF THE PREFERRED EMBODIMENTS

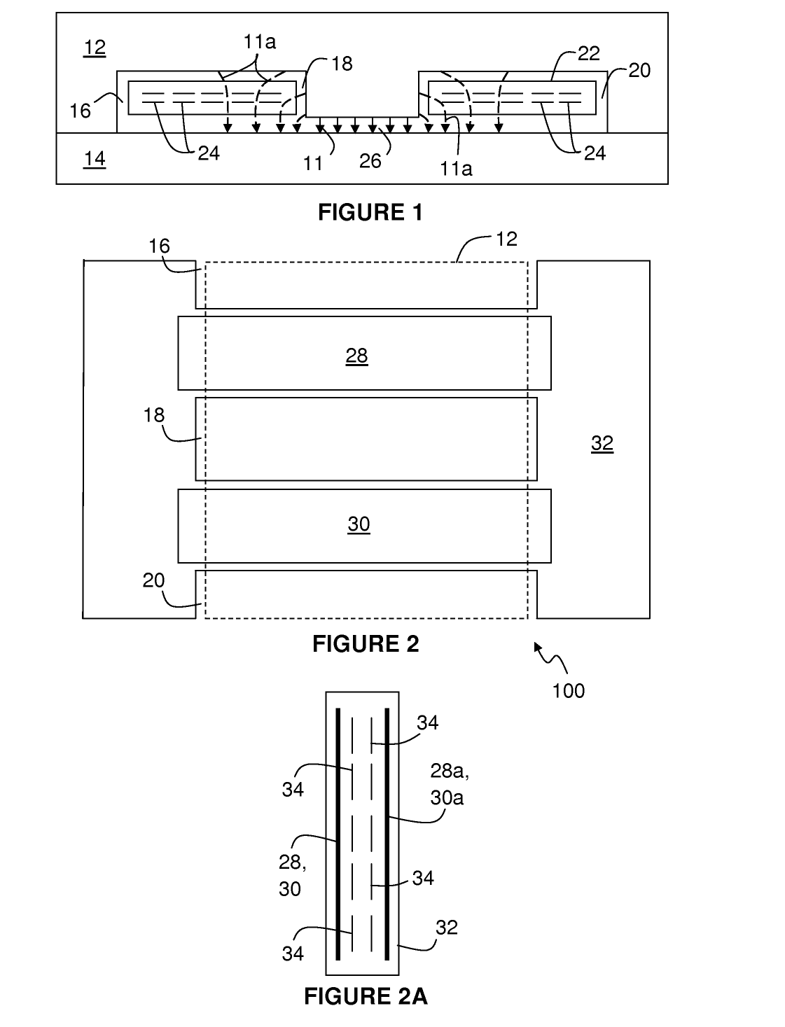

FIG. 1 is an end view of a planar transformer 10 with a ferrite core comprising an ‘E’-core 12 and an ‘I’-core 14. As is known, the cores are joined together so that the limbs of the ‘E’-core 12 pass through slots 16, 18, 20 formed in a printed circuit board (PCB) 22 which carries windings formed by copper tracks 24 in the PCB 22. A gap 26 intentionally is left in the magnetic circuit between the centre limb of the ‘E’-core 12 and the ‘I’-core 14.

In addition to the intended flux 11, stray magnetic flux 11a (shown as dashed arrows) occurs around the ferrite core and the gap 26 so that the flux does not link all the windings equally and the effects are seen either as a specific additional inductance associated with the individual windings 24, or winding voltages that are out of proportion with the turns ratio.

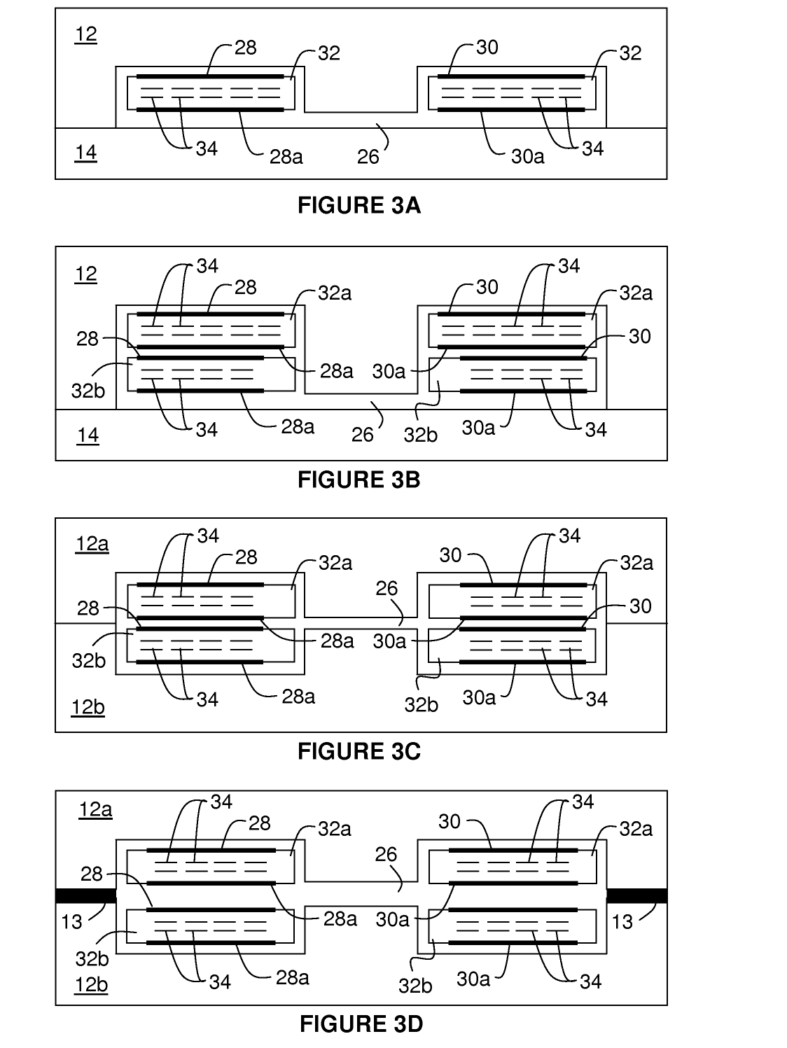

The inventors have observed that, as per the arrangements according to the invention shown in FIGS. 2 and 3, enclosing or partially enclosing windings 34 of the transformer 100 within a conductive shield 28, 30 improves the magnetic coupling between windings 34. This shielding arrangement is particularly relevant to PCB windings 34, where the shield 28, 30 may be formed by copper planed areas 28, 30 on one or more of the layers of the PCB 32.

The following describes a number of planar transformer configurations, in which the windings 34 are magnetically shielded by copper plane areas 28, 30, which effectively prevent the stray flux 11a passing through the windings 34 or the gaps therebetween. The aim of this is to improve the coupling between windings 34 linked by the same ferrite core 12, whether these are located on the same PCB 32, or on different PCBs 32a, 32b.

The copper shielding planes 28, 30 and winding tracks 34 are located on different layers of the PCB 32. However, whereas the shield 28, 30 does not need to be electrically connected, it could also form a single turn winding, or be connected to ground as both a magnetic and electrostatic shield.

It is important that the shield is not a continuous loop around the centre limb of the core 12, within the plane of the PCB 32, as this would form shorted turn. Therefore, there must be at least one insulation break in the shield 28, 30.

FIG. 2 shows two shield areas 28, 30, created on the winding PCB 32, within the footprint of the ferrite core 12. This arrangement provides sufficient shielding to create a substantial improvement in magnetic coupling between windings 34, and may be applied to one or both sides of the PCB 32.

More specifically, the shielding is provided by a pair of strips 28, 30 of copper tape applied adjacent the upper face, or E-core 12 facing side, of the PCB 32, above the winding 34 within the PCB 32. The copper tape 28, 30 extends along either side of the central limb of the ‘E’-core 12 within and, and adjacent to, the footprint of the ferrite core 12.

FIG. 2A is a cross-section of the arrangement, and illustrates an optional embodiment of the invention in which further copper strips 28a, 30a are provided so that the windings 34 are shielded from above and below.

The ferrite core 12 material may have a high dielectric constant. This, coupled with the windings 34, creates additional inter-winding, self capacitance. Whilst this can only be reduced by increasing the thickness or type of the PCB 32 insulating material between the core 12 and the winding 34, it may be important that the addition of shielding does not further increase capacitance. Shielding within the footprint of the core 12 (FIG. 2), and on the layer of the PCB 32 adjacent to the core 12, will not significantly increase capacitance.

If needed, the shield 28, 30 or shield area may be further extended to cover the area of the PCB 32 outside the ferrite core 12. However, the improvement from this modification will only be incremental , and there is a risk of increasing stray capacitance.

Referring now to FIGS. 3A to 3D of the drawings, a number of variations of ferrite core and winding arrangements is shown.

FIG. 3A shows a single PCB 32 with an ‘E’ core 12 and ‘I’ core 14 assembly with copper shielding 28, 28a, 30, 30a according to the invention provided above and below the windings 34 in the spaces 40a, 40b between the limbs of the ‘E’ core 12.

FIG. 3B is similar to FIG. 3A but in this arrangement there are two PCBs 32a, 32b that include windings 34 with copper shielding 28, 28a, 30, 30a above and below the windings 34 of each of the PCBs 32a, 32b.

FIG. 3C illustrates another arrangement with copper shielding 28, 28a, 30, 30a above and below the windings 34 of each of the PCBs 32a, 32b in which the ferrite core is provided by a pair of juxtaposed ‘E’-cores 12, 12a.

FIG. 3D is a construction which is similar to that of FIG. 3C but in which the juxtaposed ‘E’-cores 12, 12a are spaced apart by spacers 13, which increases the magnetic gap 26 between the core components 12, 12a.

Measurements taken on a planar transformer of the arrangement shown in FIG. 3B are shown in the table below under the conditions stated, but shielding was applied only in the upper sides of each PCB 32a, 32b (of the four possible locations shown) to conveniently demonstrate the principle of the invention. The primary winding was located on the lower PCB 32b, and has a turns ratio of 1:3 with respect to the secondary, on the upper PCB 32a. Both primary and secondary windings 34 have a centre tap, which is effectively bypassed to ground, thus making apparent any imbalance in AC potential at the winding ends.

The data shows that the peak-peak voltages at the ends of the primary and secondary windings 34 have a lower disparity between them when shielding 28, 30 according to the invention is provided (between 3-5%) than when no shield is provided (between 11-12%).

| | PCB | | | | | | | |
|---|---|---|---|---|---|---|---|---|
| | A001 | | A002 | | A003 | | A004 | |
| | No shield | Shield | No shield | Shield | No shield | Shield | No shield | Shield |
| Primary | | | | | | | | |
| Finish(Vp-p) | 123 | | 128.8 | 133.6 | 128 | 132 | 129 | 133 |
| Start (Vp-p) | 132 | | 136 | 136 | 136 | 135.2 | 137 | 137 |
| Secondary | | | | | | | | |
| Start (Vp-p) | 398 | 388 | 412 | 408 | 408 | 408 | 416 | 412 |
| Finish(Vp-p) | 350 | 368 | 364 | 392 | 364 | 392 | 370 | 400 |
| Difference | 12% | 5% | 12% | 4% | 11% | 4% | 12% | 3% |
| Frequency (MHz) | 1.5 | | 1.7 | 1.78 | 1.69 | 1.76 | 1.68 | 1.76 |

The measurements were taken on a planar transformer comprising ferrite E and I cores 12, 14, linked by two PCBs 32a, 32b. The magnetic circuit included a gap 26 between the centre leg of the E-core 12 and the I-core 14. The PCB 32b closest to the magnetic gap 26 contained the centre tapped primary. The second PCB 32a contained twelve centre tapped secondary windings 34.

Shielding was added to the top surface of the second PCB 32a, using two lengths of copper tape 28, 30.

The peak-peak voltages at the ends of the primary and secondary windings 34 were compared with and without shielding 28, 30.

In all cases the circuit was set to provide a nominal 400 Vp-p at the secondary winding. Tests were made on four PCBs 32 (A001-A004).

It will be appreciated by those skilled in the art that any number of combinations of the aforementioned features and/or those shown in the appended drawings provide clear advantages over the prior art and are therefore within the scope of the invention described herein.

1. A planar transformer comprising
a plurality of conductive windings provided by a printed circuit board and linked by a common ferrite core passing through the printed circuit board,
wherein the transformer windings or the gaps therebetween are at least partially magnetically shielded from the ferrite core by a conductive non-continuous shield.

2. A planar transformer according to claim 1, wherein the conductive shield forms a single turn winding.

3. A planar transformer according to claim 1, wherein the conductive shield is connected to ground as both a magnetic and electrostatic shield.

4. A planar transformer according to claim 1, wherein the conductive shield is on an upstream side of the printed circuit board in a direction of the magnetic flux.

5. A planar transformer according to claim 1, wherein the conductive shield is formed by copper shielding planes on one or more layers of the printed circuit board.

6. A planar transformer according to claim 5, wherein the copper shielding planes and the transformer windings are located on different layers of the printed circuit board.

7. A planar transformer according to claim 1, wherein the conductive shield extends to cover an area of the printed circuit board outside the ferrite core.

8. A planar transformer according to claim 1, wherein the ferrite core comprises an E-shape and the conductive shield is located between the windings and the E-shaped ferrite core

9. A planar transformer according to claim 8, wherein the conductive shield is on an E-shaped ferrite core facing side of the printed circuit board.

10. A planar transformer according to claim 8 comprising a further conductive shield located on a side of the printed circuit board opposite the ferrite core.

11. A planar transformer according to claim 1, wherein the windings and the conductive shielding are spaced from a transformer magnetic gap for minimising eddy current losses.

12. A planar transformer according to claim 11, wherein space between the conductive shield and the magnetic gap is substantially five times the length of the magnetic gap.

13. A planar transformer according to claim 1, wherein the conductive shield comprises a metal foil disposed between the printed circuit board and the ferrite core.

14. A circuit board for an ion guide of a mass spectrometer having a planar transformer according to claim 1.

15. An ion guide comprising a planar transformer according to claim 1.

16. A mass spectrometer comprising a planar transformer according to claim 1.

17. A planar transformer according to claim 9 comprising a further conductive shield located on the E-shaped ferrite core facing side of the printed circuit board.

18. A mass spectrometer comprising a circuit board according to claim 14.

19. A mass spectrometer comprising an ion guide according to claim 15.
